(19) United States
(12) Patent Application Publication
(10) Pub. No.: US 2006/0065686 A1
(43) Pub. Date: Mar. 30, 2006

(54) Vehicle roof rack

(76) Inventor: David R. Furtado, Van Nuys, CA (US)

Correspondence Address: BRUCE E. WEIR, 12 SPARROW VALLEY COURT, MONTGOMERY VILLAGE, MD, 20886-1265, US

(21) Appl. No.: 10/954,894

(22) Filed: Sep. 30, 2004

(51) Int. Cl. B60R 9/00

(52) U.S. Cl. 224/319

(57) ABSTRACT

A vehicle roof rack fits within and attaches to an existing roof rack, providing one or more platforms to support and secure sheet materials, boards, pipes, and other large objects above the roof of a vehicle. A platform may include a T-channel that accepts load-carrying accessories to secure pipes, boards, and other objects that may roll or slide on a flat platform. Objects are secured to a platform roof rack with adjustable straps.

### BACKGROUND

A typical passenger vehicle is designed to carry a few passengers and a minimal amount of cargo. People who need more cargo capacity have traditionally chosen vans, pickups, flatbeds, or other larger vehicles. However, these larger vehicles may be difficult to maneuver, expensive, lacking in amenities, or for many other reasons unsuitable for non-business use. A Sport Utility Vehicle (SUV) provides a popular compromise between comfort, interior space, exterior size, ground clearance, maneuverability, and cost.

Although an SUV provides significantly more interior space than a typical passenger vehicle, SUV owners may on occasion still need the ability to carry objects that will not fit inside the vehicle, such as plywood, drywall, boards, or long pipes. While most SUVs are equipped with a roof rack, factory-installed roof racks are usually inadequate for safely carrying oversized objects. Many aftermarket racks are available for carrying luggage, bicycles, kayaks, and other such objects, but these aftermarket racks are generally not designed for quick temporary installation and are awkward to adapt for carrying oversized objects.

What is needed is a rack that may be quickly, easily, and temporarily attached to the roof of an SUV over an existing factory rack to carry oversized objects.

### SUMMARY

A vehicle roof rack comprises a base with at least two feet disposed on opposite sides of the base. The feet extend far enough below the base bottom between the feet to provide clearance between the base bottom and a vehicle roof when the feet rest upon a vehicle roof. The base has strap connector bars or other means for attaching the base to the vehicle roof, typically to a factory-installed roof rack. A platform attached to the top of the base supports loads. The platform may have a T-channel that engages a T-connector on a load-carrying accessory designed to secure tubes, boards, and other items that may roll or slide on a platform.

The platform may be attached directly to the base. Alternatively, a platform support may be attached to or integral with the base, and the platform attached to or integral with the top of the platform support. The base may be divided into two sections that are adjustably attached by a screw. The screw is divided approximately in half, with one half having a right-hand thread and the other half having a left-hand thread, so that rotating the screw draws the base sections together or pushes them apart. Each of the two base sections has a T-channel in its top surface that engages a T-connecter attached to or integral with the bottom surface of the platform support, allowing the base sections to slide apart or together while remaining securely attached to the platform support. A user may thereby adjust the base to place the feet inside a factory-installed rack but close to the edges of the vehicle roof where the body metal is least prone to flexing.

All of these features and advantages of the present invention, and more, are illustrated below in the drawings and detailed description that follow.

### BRIEF DESCRIPTION OF THE DRAWINGS

FIG. 1 shows a perspective view of a preferred embodiment of the present invention.

FIG. 2 shows a perspective view of the underside of a preferred embodiment of the present invention.

FIG. 3 shows a strap assembly that may be used to attach the present invention to a vehicle or to attach a load to the present invention.

FIG. 4 shows a preferred embodiment of an attachment hook that may be used to attach the present invention to a vehicle.

FIG. 5 shows a strap sheath encasing a portion of a strap assembly.

FIG. 6 shows a preferred mode of utilizing the present invention.

FIG. 7 shows an alternate embodiment of the present invention having an adjustable base.

FIG. 8 shows an end view of the embodiment of FIG. 7.

FIG. 9 shows a sock that may optionally cover one or more feet.

FIG. 10 shows a perspective view of a load-carrying accessory for rounded objects.

FIG. 11 shows a perspective view of a load-carrying accessory for narrow objects.

FIG. 12 shows a perspective view of a load-carrying accessory for rounded objects including a security pin.

FIG. 13 shows a perspective view of a load-carrying accessory for narrow objects including a security pin.

FIG. 14 shows a plan view of a platform with a load-carrying accessory attached.

FIG. 15 shows an elevation view of a platform with a load-carrying accessory attached.

### DETAILED DESCRIPTION

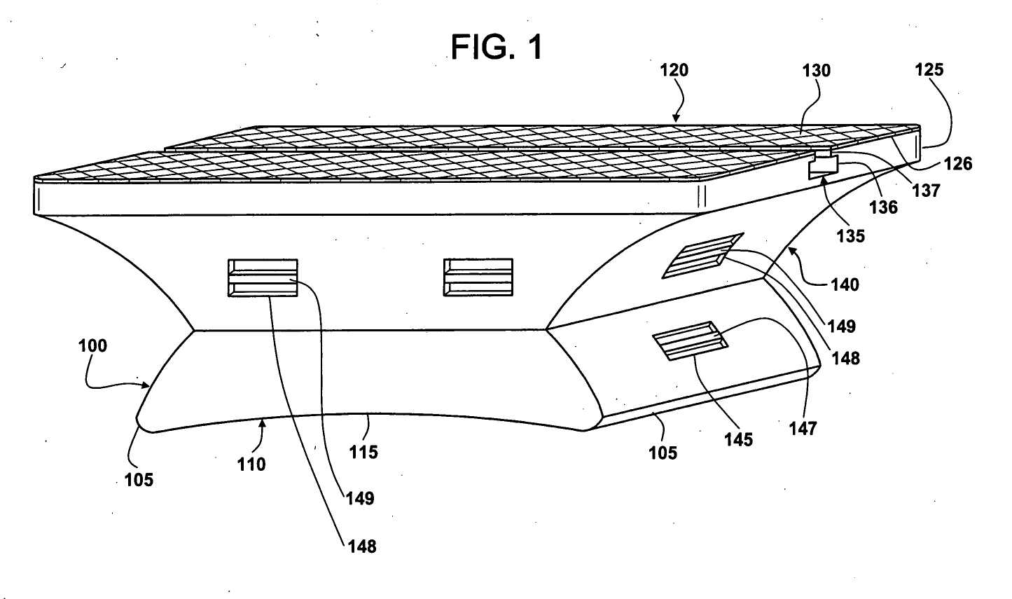

The present invention is a vehicle roof rack configured to attach quickly to the roof of a vehicle to support and secure large objects. FIG. 1 shows a preferred embodiment of the present invention. A base 100 with a roughly rectangular horizontal cross-section has at least two feet 105, with at least one foot on each of at least two opposing edges of the base 100. A base bottom surface 110 between the feet 105 is elevated to provide clearance between the base bottom surface 110 and the roof of a vehicle (not shown).

The preferred embodiment of FIG. 1 shows rounded feet 105 and a base bottom surface 110 that arches between feet 105, with approximately three centimeters of clearance between the center 115 of the base bottom surface 110 and a flat surface (not shown) on which the base 100 might rest. Alternate embodiments might have flat or angled feet that provide clearance by extending below a flat base bottom surface that is angled or raised. More clearance may be provided as needed for certain vehicles.

A platform 120 may be mounted directly on the base 100 or, as shown in the preferred embodiment of FIG. 1, mounted on a platform support 140 that is mounted on the base 100. A platform support may be necessary to raise a platform above a factory-installed rack. Otherwise, a platform mounted directly on a base maintains a lower center of gravity and presents a smaller surface area to crosswinds. A preferred platform 120 comprises a flat rectangular panel 125 of sufficient stiffness to hold its shape under a load of 100 kilograms, with a non-skid surface protector 130 attached to the upper surface of the panel 125. The surface protector 130 is made of rubber or another resilient, high-friction surface material as is known in the art. In an alternate embodiment, a non-skid surface may be molded or machined into the upper surface of the panel 125.

A preferred platform 120 also has at least one T-channel 135 molded, formed, or machined into the panel 125. A preferred T-channel 135 is an elongated cavity with a lower portion 136 that is disposed within the interior of the panel 125. A narrower upper portion 137 communicates between the lower portion 136 and the upper surface 126 and forms a linear opening in the upper surface of the panel 125 and the surface protector 130.

In the preferred embodiment of FIG. 1, the T-channel 135 is open at both ends and is oriented parallel to the long dimension of the platform 120. Alternate embodiments may have more than one T-channel. T-channels may open to only one edge of the platform 120 and may be oriented in any direction or directions preferred for specific applications. FIG. 1 shows a T-channel 135 with a cross-section having parallel opposing sides and orthogonal adjacent sides. Alternate T-channel embodiments may have sides that are otherwise angled or rounded to accommodate specific applications or manufacturing processes.

Since the longest dimension of the platform 120 shown in FIG. 1 exceeds the distance between feet 105, the platform support 140 of FIG. 1 flares outward as it rises from the base 100 to the platform 120. Both the base 100 and the platform support 140 have recessed cavities with strap connector bars. At least one end of a strap connector bar is connected to a side of a recessed cavity, with enough space remaining between the strap connector bar and the sides of a cavity to allow passage of one or more straps around the bar.

FIG. 1 shows a recessed cavity 145 with a strap connector bar 147 on the side of the base 100 adjacent a foot. The same configuration is present on the opposite side (not shown) of the base 100 adjacent the opposite foot. Likewise, at least one recessed cavity 148 with a strap connector bar 149 is present on each side of the platform support 140. In alternate embodiments strap connectors may protrude from the surface of the present invention in convenient locations.

The base 100, platform support 140, panel 125, and strap connector bars 147, 149 may be assembled from separate components or molded, formed, or machined as a single unit. The present invention may be made of wood or metal, but preferred embodiments are made from polyethylene, acrylonitrile butadiene styrene, or fiberglass. The base 100, platform support 140, and panel 125 may comprise a single hollow unit. In an alternate embodiment, the panel 125 may have a solid core. In still another embodiment, assembled sections may form separate hollow compartments.

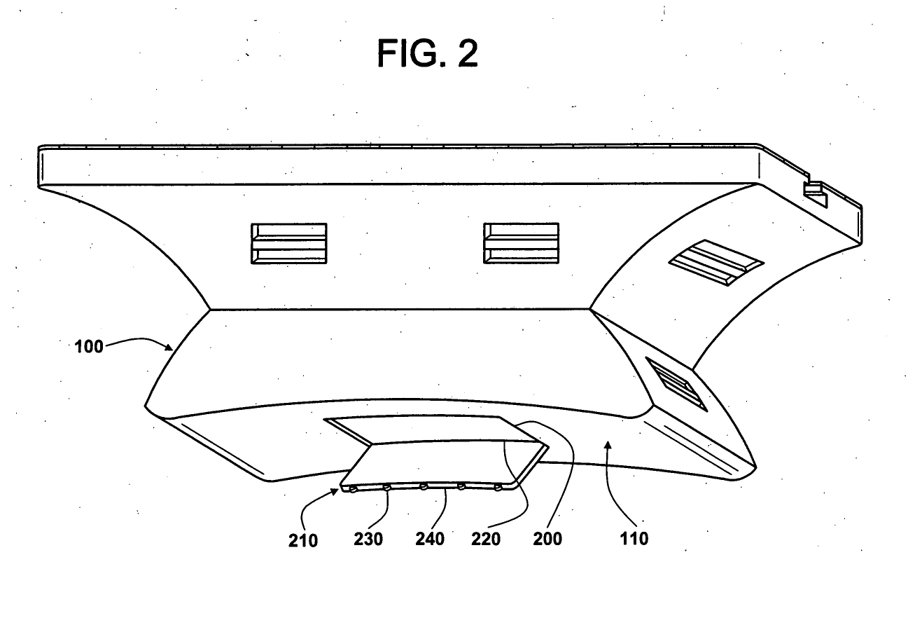

FIG. 2 shows a perspective view of the underside of a preferred embodiment of the present invention. A storage port 200 in the base bottom surface 110 provides access to the hollow interior of the base 100. The storage port 200 may be closed by a door panel 210. In a preferred embodiment, the door panel 210 is hinged at one edge 220 and has one or more projections 230 on the opposite edge 240 that engage an opposite edge of the storage port 200 to hold the door panel 210 in a closed position. Alternate embodiments may utilize hooks, latches, and other closure devices known in the art. Alternate embodiments may have one or more storage ports providing access to the interior of the platform support 140.

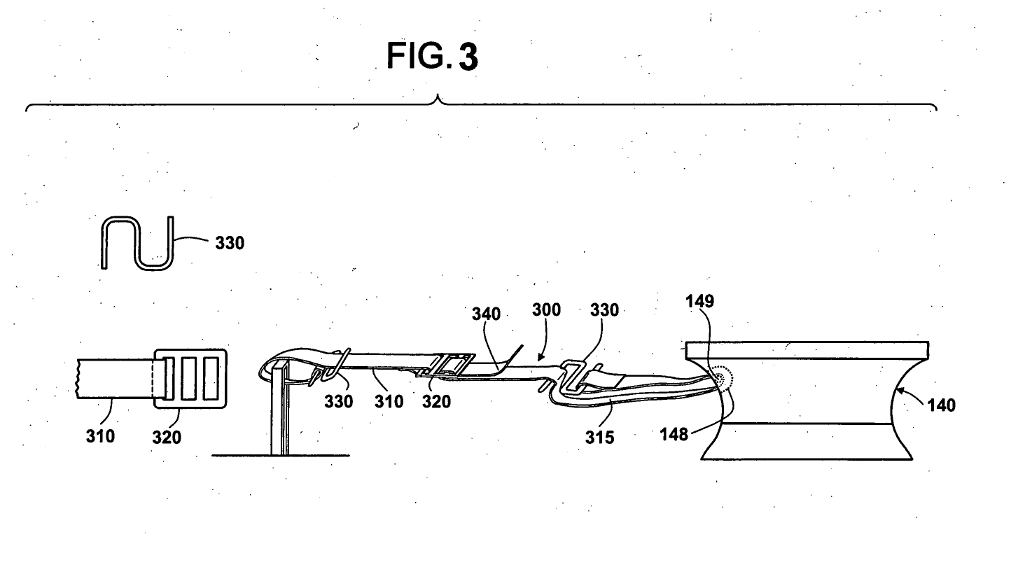

FIG. 3 shows a strap assembly 300 that may be used to attach the present invention to a vehicle or to attach a load to the present invention. A first web strap 310 made of nylon, polypropylene, cotton, or other materials known in the art is cut to an appropriate length and a loop is formed in each end. An adjustment buckle 320 as is known in the art is attached to one loop. A second, similar web strap 315 is cut to length and a loop is formed in one end. The free end 340 of the second web strap 315 is threaded through the adjustment buckle 320.

In use, a loop at one end of the resulting strap assembly 300 is passed around some fixture attached to the vehicle and attached to the proximate strap with an S-hook 330. The loop at the opposite end of the strap assembly 300 is passed through a recessed cavity 148 in the platform support 14Q or another part of the present invention, around a strap connector bar 149, and attached to the proximate strap with an S-hook 330. Once attached, the strap assembly 300 may be tightened with a tug on the free end 340 of the second web strap 315. A strap assembly 300 used to attach a load to a vehicle may be attached between connector bars on opposite sides of the present invention, or between vehicle body parts on opposite sides of the vehicle. Ropes, chains, and other known attachment means may be used instead of or in addition to the strap assembly 300.

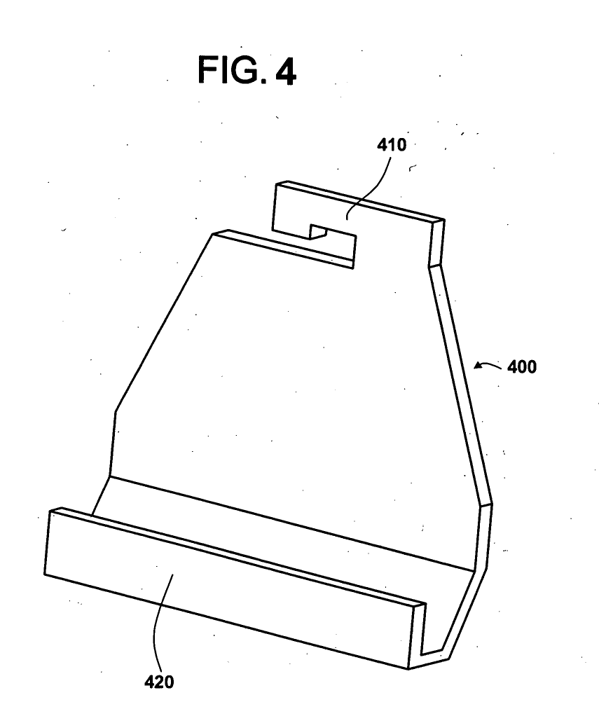

FIG. 4 shows a preferred embodiment of an attachment hook 400 that may be used to attach the present invention to a vehicle. The attachment hook 400 may be formed from sheet metal, cut from extruded metal or plastic, or fabricated by other means known in the art. An upper hook 410 is sized and oriented to accept a strap assembly. A lower hook 420 is sized and oriented to span and attach to a vehicle bumper or other body part.

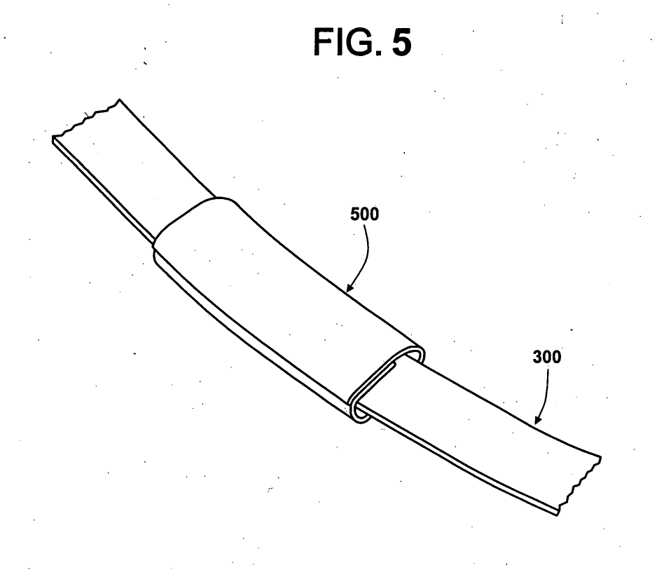

FIG. 5 shows a strap sheath 500 encasing a portion of a strap assembly 300. A strap sheath 500 slides onto a strap assembly 300 and is positioned by a user at a point where the strap assembly 300 contacts a painted vehicle body part. Preferred strap assemblies may include some cushioning and may be made from neoprene, cloth, or another non-abrasive material.

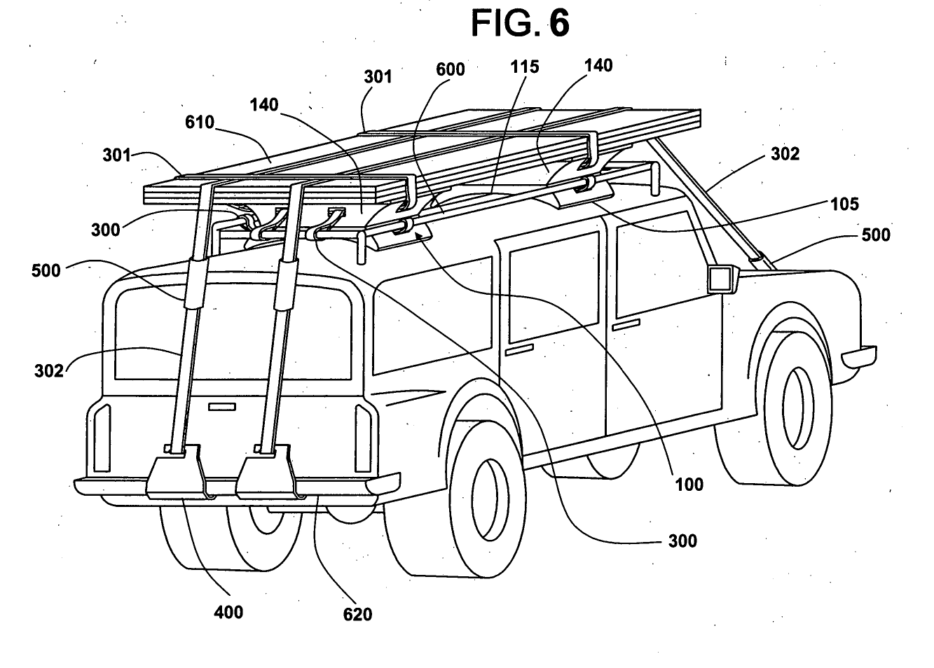

FIG. 6 shows a preferred mode of utilizing the present invention. Two units of the present invention rest on the roof of a vehicle with the feet 105 of each unit contacting the roof. Since a vehicle roof tends to flex less near the vertical sides of the vehicle and hence be better able to support weight without damage to the vehicle, the span between feet is selected so that the base fits just within a factory-installed vehicle roof rack but as close to the edges of the roof as possible. The center 115 of the base bottom surface (not shown) provides clearance between the base bottom surface and the vehicle roof, directing the load carried by the present invention toward the stiffer portions of the vehicle roof near the edges of the roof. More than two units may be used if space permits.

Short strap assemblies 300 attach to connector bars on the bases 100 and forward and rear faces of the platform supports 140 to the vehicle roof rack 600. Longer strap assemblies 301 secure a load 610 laterally by attaching to connector bars on opposite sides of platform supports 140. Still longer strap assemblies 302 secure a load fore and aft by attaching to attachment hooks 400 hooked onto rear 620 and front (not shown) vehicle bumpers. To minimize vehicle body damage, strap sheathes 500 are positioned on each strap assembly 302 at points where a strap assembly 302 contacts a painted portion of the vehicle body. Embodiments having a platform mounted directly on a base have at least one connector bar on each vertical side. Single units of the present invention may be used to carry loads with dimensions small enough to be adequately supported by one platform.

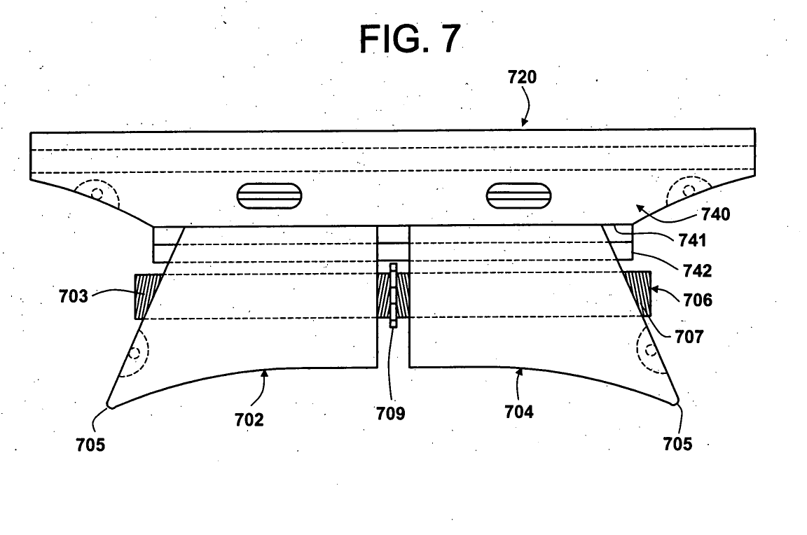

FIG. 7 shows an alternate embodiment of the present invention having an adjustable base, allowing a user to adjust this embodiment to fit vehicle roofs of different widths. The embodiment of FIG. 7 has a platform 720 similar to that of FIG. 1. The platform support 740 is also similar to the platform support of FIG. 1, with the difference that the platform support 740 of FIG. 7 has a T-connector 742 formed on or attached to the bottom surface 741 of the platform support 740. In the embodiment of FIG. 7, the T-connector 742 is parallel to the long dimension of the platform 720, although other configurations may utilized as needed.

In this alternate embodiment, the base is divided into a first base section 702 and a second base section 704, each with a T-channel in its upper surface (not shown) that mates with the T-connector 742 to allow the base sections 702, 704 to slide beneath the platform support 740 while remaining attached to the T-connector 742. One or both base sections may have storage ports (not shown) to provide access to interior storage space. The platform support 740 may also have one or more storage ports.

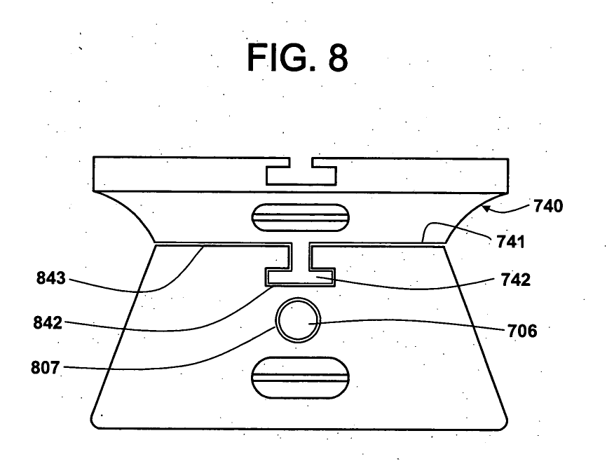

FIG. 8 shows an end view of the embodiment of FIG. 7 with the separation between the bottom surface 741 of the platform support 740, the upper surface 843 of a base section 702, 704, the T-connector 742, and a T-channel 842 exaggerated for clarity.

Returning to FIG. 7, the base sections 702, 704 are joined and adjustably positioned by a screw 706 passing through threaded holes (not shown) in the base sections 702, 704. The screw 706 typically has coarse threads 703, 707 and is made of the same material as the base sections, although it may be made of any suitable material known in the art. FIG. 8 shows the separation between the screw 706 and a hole 807 exaggerated for clarity. Each hole is threaded to correspond in pitch and handedness to the portion of the screw 706 contained within.

FIG. 7 shows an adjustment ring 709 attached to the center of the screw 706. The screw threads 703, 707 on either side of the adjustment ring 709 are of opposite handedness, so that rotation of the adjustment ring 709 in one direction draws the base sections 702, 704 together while rotation in the opposite direction pushes the base sections 702, 704 apart, allowing a user to adjust the feet 705 to a desired separation.

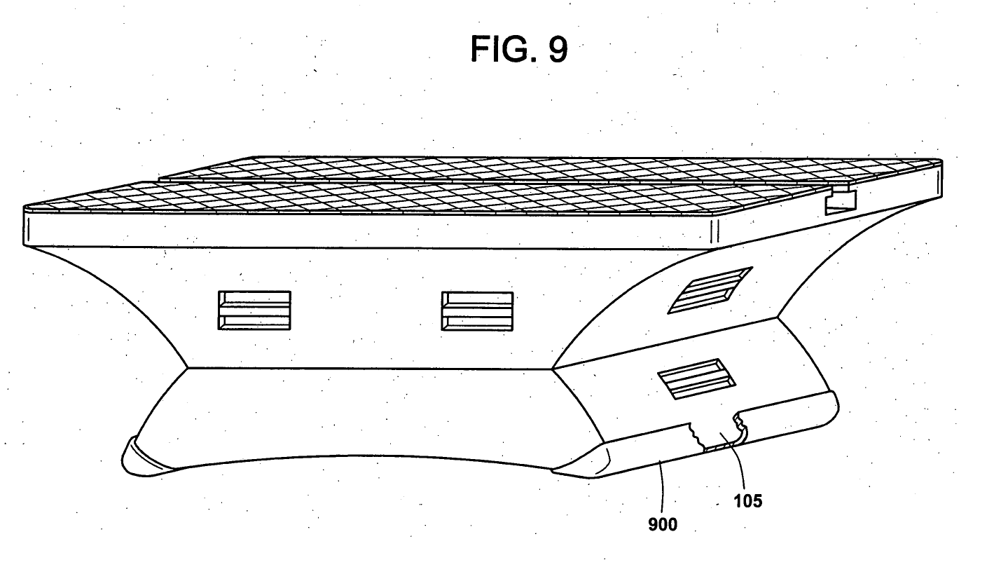

FIG. 9 shows a sock 900 that may optionally cover one or more feet 105 on any embodiment of the present invention to reduce wear on painted vehicle body surfaces. A preferred embodiment of the sock 900 is made of neoprene and is retained on a foot 105 by friction. Alternate embodiments of the sock 900 may be made any cloth or suitable material and may by glued, clamped, screwed, or otherwise attached to a foot 105 by means well-known in the art.

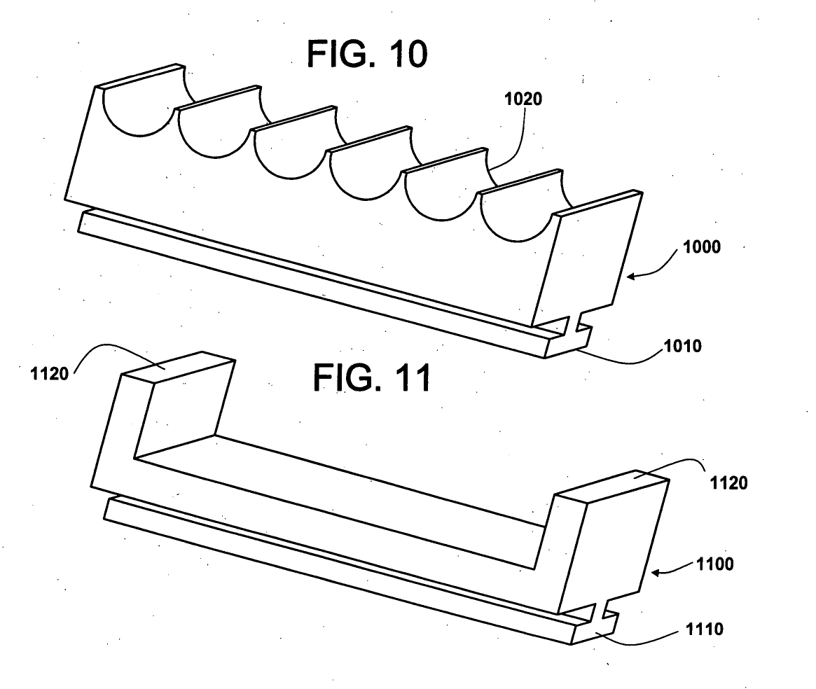

FIG. 10 shows a perspective view of an optional load-carrying accessory that may be used with the present invention. A tube support block 1000 has a T-connector 1010 sized and shaped to slide securely into a T-channel in a platform. The upper surface 1020 of the tube support block 1000 is contoured with one or more semi-cylindrical cavities that partially contain and secure pipe or other tubular load items. Compatible though not necessarily identical load-carrying accessories may be attached to at least two units of the present invention to facilitate secure transportation of items that might otherwise roll or slide upon a platform. The tube support block 1000 may be solid or hollow and made of polyethylene, acrylonitrile butadiene styrene, metal, wood, fiberglass, or other materials known in the art.

FIG. 11 shows a perspective view of another optional load-carrying accessory that may be used with the present invention. A support block 1100 has a T-connector 1110 sized and shaped to slide securely into a T-channel in a platform. The support block 1000 has a raised edge 1120 at each end to prevent load items from sliding laterally from the present invention. The support 1100 block may be solid or hollow and made of polyethylene, acrylonitrile butadiene styrene, metal, wood, fiberglass, or other materials known in the art.

The accessories of FIG. 10 and FIG. 11 are meant only to exemplify and not to limit the possible shapes of load-carrying accessories that may be used with the present invention, which contemplates the use of many other shapes optimized to stabilize and secure a variety of specific loads.

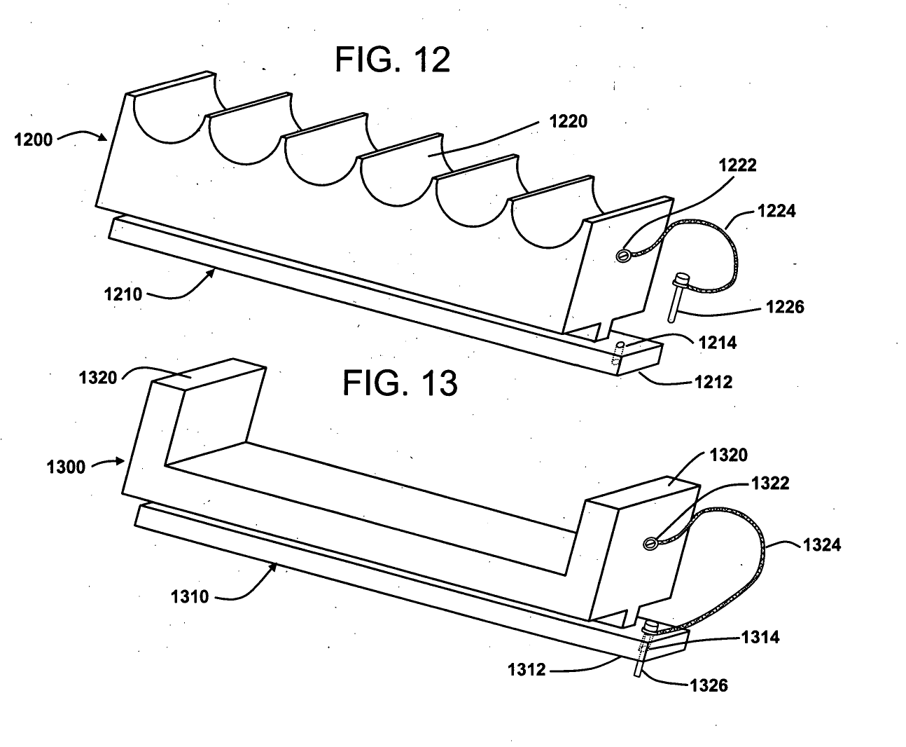

FIG. 12 shows a perspective view of an optional load-carrying accessory that includes a security pin. A tube support block 1200 has a T-connector 1210 sized and shaped to slide securely into a T-channel in a platform. The upper surface 1220 of the tube support block 1200 is contoured with one or more semi-cylindrical cavities that partially contain and secure pipe or other tubular load items. A T-connector extension 1212 contains a pin hole 1214 sized and positioned to accept security pin 1226. The security pin 1226 is attached to the tube support block 1200 by a security tether 1224 that is attached to the tube support block by a screw 1222 or other attachment means known in the art. The tube support block 1200 may be solid or hollow and made of polyethylene, acrylonitrile butadiene styrene, metal, wood, fiberglass, or other materials known in the art.

Similarly, FIG. 13 shows a perspective view of another optional load-carrying accessory that includes a security pin. A support block 1300 has a T-connector 1310 sized and shaped to slide securely into a T-channel in a platform. The support block 1300 has a raised edge 1320 at each end to prevent load items from sliding laterally from the present invention. A T-connector extension 1312 contains a pin hole 1314 sized and positioned to accept security pin 1326. The security pin 1326 is attached to the support block 1300 by a security tether 1324 that is attached to the tube support block by a screw 1322 or other attachment means known in the art. The tube support block 1300 may be solid or hollow and made of polyethylene, acrylonitrile butadiene styrene, metal, wood, fiberglass, or other materials known in the art.

The accessories of FIG. 12 and FIG. 13 are meant only to exemplify and not to limit the possible shapes of load-carrying accessories that may be used with the present invention, which contemplates the use of many other shapes optimized to stabilize and secure a variety of specific loads.

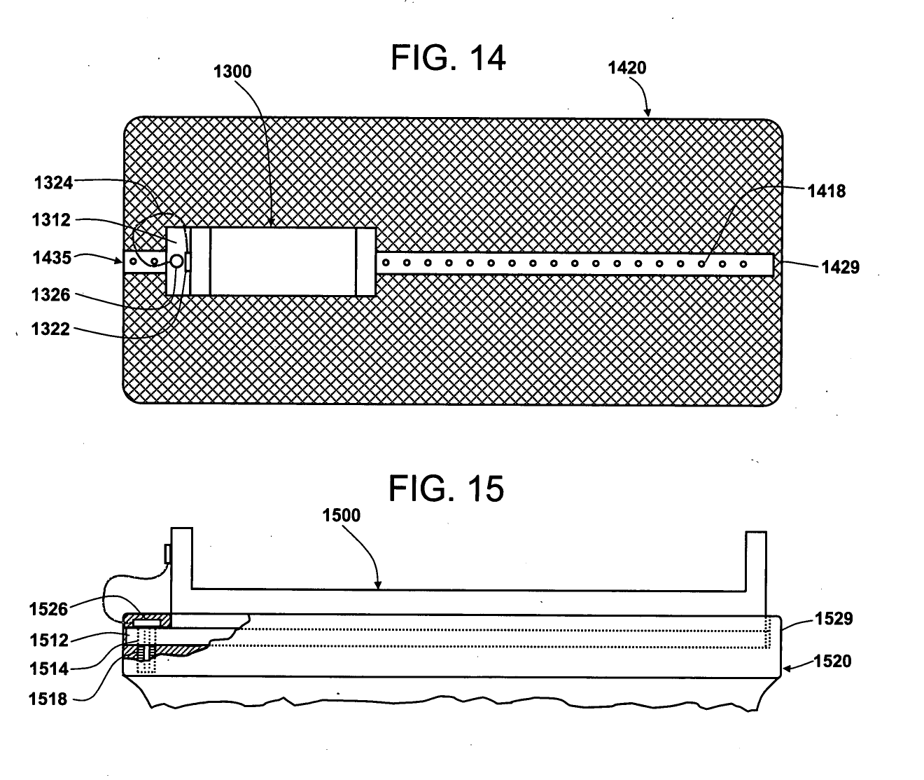

FIG. 14 shows a plan view of a platform 1420 with a load-carrying accessory attached. A T-connector (not shown) attached to a support block 1300 slides within a T-channel 1435 to a position of a user's choice. One or more pin holes 1418 accepts a security pin 1326 that is attached to the support block 1300 by a security tether 1324 that is attached to the support block by a screw 1322. The support block 1300 may be moved to and secured at any position along the T-channel 1435 defined by a pin hole 1418. This embodiment includes an end stop 1429 at one end of the T-channel that prevents the support block 1300 from sliding off one side of the platform 1420.

FIG. 15 shows a elevation view of the platform with a load-carrying accessory attached. The embodiment of FIG. 15 shows a support block 1500 that spans most of the long dimension of the platform 1520 and is positioned by an end stop 1529 at one end of the platform 1520 and a security pin 1526 at the other end. The security pin 1526 passes through a pin hole 1514 in a T-connector extension 1512 into another pin hole 1518 in the platform 1520. The sizes of the pin holes 1514, 1518 depicted in FIG. 15 are exaggerated for clarity.

Alternate embodiments of the present invention may utilize load-carrying accessories with integrated connector bars or other known strap-anchoring means, enabling a user to strap loads directly to load-carrying accessories rather than to a platform support or a base.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

1. A vehicle roof rack, comprising:
a base, the base having a base bottom, a base top, and at least a first base side and a second base side, the first base side including at least a first foot, the second base side including at least a second foot, the first foot and the second foot extending below at least a portion of the bottom of the base, the base having means for attachment to a vehicle roof; and
a platform, the platform attached to the base top.

2. A vehicle roof rack as claimed in claim 1, wherein the platform comprises a panel and a channel, at least a portion of the channel disposed within the panel.

3. A vehicle roof rack as claimed in claim 2, further comprising a load-carrying accessory, the load-carrying accessory having a connector that slideably engages the channel.

4. A vehicle roof rack, comprising:
a base, the base having a base bottom, a base top, and at least a first base side and a second base side, the first base side including at least a first foot, the second base side including at least a second foot, the first foot and the second foot extending below at least a portion of the bottom of the base, the base having means for attachment to a vehicle roof;
a platform; and
a platform support, the platform support having a support bottom, a support top, and at least a first support side and a second support side, the support bottom being attached to the base top, the platform being attached to the support top, the platform support having means for attachment to a vehicle roof, the platform support further having load attachment means.

5. A vehicle roof rack as claimed in claim 4, wherein the platform comprises a panel and a channel, at least a portion of the channel disposed within the panel.

6. A vehicle roof rack as claimed in claim 5, further comprising a load-carrying accessory, the load-carrying accessory having a connector that slideably engages the channel.

7. A vehicle roof rack, comprising:
a first base section, the first base section having at least a first foot, the first base section having means for attachment to a vehicle roof;
a second base section, the second base section having at least a second foot, the second base section having means for attachment to a vehicle roof, the second base section adjustably attached to the first base section;
a platform; and
a platform support, the platform support having a support bottom, a support top, and at least a first support side and a second support side, the platform being attached to the support top, the first base section and the second base section being slideably attached to the support bottom, the platform support having means for attachment to a vehicle roof, the platform support having load attachment means.

8. A vehicle roof rack as claimed in claim 7, wherein the platform comprises a panel and a channel, at least a portion of the channel disposed within the panel.

9. A vehicle roof rack as claimed in claim 8, further comprising a load-carrying accessory, the load-carrying accessory having a connector that slideably engages the channel.
